(19) United States
(12) Patent Application Publication
(10) Pub. No.: US 2021/0333403 A1
(43) Pub. Date: Oct. 28, 2021

(54) MOVABLE ELECTRONIC DEVICE AND OPERATING METHOD THEREOF

(71) Applicants: LITE-ON ELECTRONICS (GUANGZHOU) LIMITED, Guangzhou (CN); Lite-On Technology Corporation, Taipei (TW)

(72) Inventors: Shou-Te Wei, Taipei (TW); Wei-Chih Chen, Taipei (TW)

(73) Assignees: LITE-ON ELECTRONICS (GUANGZHOU) LIMITED, Guangzhou (CN); Lite-On Technology Corporation, Taipei (TW)

(21) Appl. No.: 16/879,774

(22) Filed: May 21, 2020

(30) Foreign Application Priority Data
Apr. 27, 2020 (TW) 109113987

(51) Int. Cl. G01S 17/894; G01S 17/86; G01S 7/497; G01S 17/933; G01S 7/481; B64C 39/02; B64D 47/02

(52) U.S. Cl. CPC G01S 17/894; G01S 17/86; G01S 7/497; B64C 2201/123; G01S 7/4817; B64C 39/024; B64D 47/02; G01S 17/933

(57) ABSTRACT

A movable electronic device and an operating method thereof are provided. The movable electronic device includes a first image capturer, a second image capturer, a processor and a light source generator. The first image capturer is configured to capture images of a moving object and generate position information according to the images. The second image capturer is configured to image the object according to the position information and generate time-of-flight sensing information. The processor is configured to generate a control signal according to the position information and calculate depth information related to the object according to the time-of-flight sensing information. The light source generator generates a light beam on the object according to the control signal.

### CROSS-REFERENCE TO RELATED APPLICATION

This application claims the priority benefit of Taiwan application serial no. 109113987, filed on Apr. 27, 2020. The entirety of the above-mentioned patent application is hereby incorporated by reference herein and made a part of this specification.

### BACKGROUND

### Technical Field

The disclosure relates to an electronic device, and particularly relates to a movable electronic device and an operating method thereof.

### Description of Related Art

As technology advances, it has become an important trend in many industries to assist professionals with an unmanned aerial vehicle (UAV) in performing tasks to improve work efficiency.

Since the UAV needs to avoid colliding with obstacles during flight, the UAV usually performs distance detection with respect to the obstacles through a built-in sensor to detect the distance from the obstacles.

However, among the UAV distance detection technologies in the art, there usually exist problems such as an insufficient detection range and a lower accuracy of detecting the obstacle. Therefore, how to effectively increase the detection range and increase the accuracy of detecting the obstacles is an issue for those skilled in the art.

### SUMMARY

The disclosure provides a movable electronic device and an operating method thereof, in which through rotation of a rotating platform, a light emitter can be oriented in a direction corresponding to a moving object and project a light beam with a narrow field of view (FOV) on the object, in order to increase the detection range of the movable electronic device and the accuracy of calculating the depth information related to the object.

The movable electronic device of the disclosure includes a first image capturer, a second image capturer, a processor, and a light source generator. The first image capturer is configured to capture an image of an object which is moving and generate position information according to the image. The second image capturer receives the position information, and is configured to image the object according to the position information and generate time-of-flight sensing information. The processor is coupled to the first image capturer and the second image capturer, and is configured to generate a control signal according to the position information and calculate depth information related to the object according to the time-of-flight sensing information. The light source generator is coupled to the processor, and generates a light beam on the object according to the control signal.

The operating method of a movable electronic device of the disclosure includes the following steps. A first image capturer is provided to capture an image of an object which is moving and generate position information according to the image. A second image capturer is provided to image the object according to the position information and generate time-of-flight sensing information. A processor is provided to generate a control signal according to the position information and calculate depth information related to the objects according to the time-of-flight sensing information. A light source generator is provided to generate a light beam on the object according to the control signal.

Based on the foregoing, the light source generator of the movable electronic device according to the embodiments of the disclosure can rotate the rotating platform to a specified position or angle according to the position information provided by the first image capturer, such that the light emitter is oriented in a specified direction and generates a light beam with a narrow FOV on the moving object. In this manner, the movable electronic device of the disclosure can effectively increase the detection range and detection speed for detecting objects, and effectively increase the accuracy of calculating the depth information related to the object by the processor.

### BRIEF DESCRIPTION OF THE DRAWINGS

FIG. 1 is a schematic circuit block diagram of a movable electronic device according to an embodiment of the disclosure.

FIG. 2A to FIG. 2C are schematic diagrams of a light emitter of FIG. 1 generating light beams in various different forms when a rotating platform rotates in different directions according to an embodiment of the disclosure.

FIG. 3 is a flowchart of an operating method of a movable electronic device according to an embodiment of the disclosure.

### DESCRIPTION OF THE EMBODIMENTS

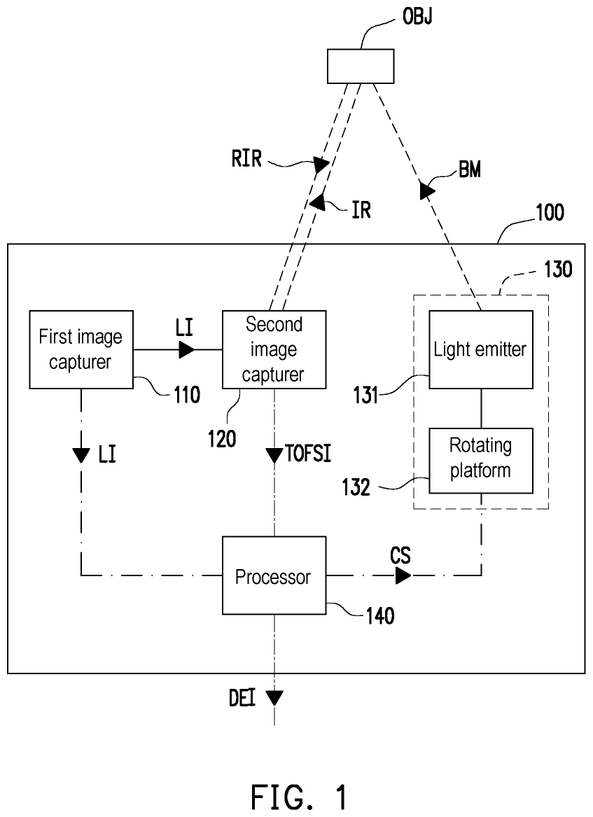

FIG. 1 is a schematic circuit block diagram of a movable electronic device according to an embodiment of the disclosure. Referring to FIG. 1, a movable electronic device 100 includes a first image capturer 110, a second image capturer 120, a light source generator 130, and a processor 140. The movable electronic device 100 in this embodiment may, for instance, be an unmanned aerial vehicle (UAV) (but is not limited thereto). In addition, when the movable electronic device 100 performs a traveling operation, the movable electronic device 100 may detect a moving object in order to calculate a distance to the object, and thereby obtain depth information related to the object.

In this embodiment, the first image capturer 110 may be configured to detect a moving object OBJ, so as to capture an image of the object OBJ, and obtain position information LI related to the object OBJ according to the image. The position information LI may include coordinate information related to the object OBJ and a size of the object OBJ.

In addition, under some design requirements (in some embodiments), the first image capturer 110 may be coupled to the second image capturer 120, and the first image capturer 110 may provide the position information LI to the second image capturer 120 through wired transmission, so that the second image capturer 120 can image (e.g., by photo shooting) the object OBJ according to the position information LI to obtain time-of-flight sensing information TOFSI. In contrast, under some other design requirements (in some other embodiments), the first image capturer 110 may provide the position information LI to the second image capturer 120 through wireless transmission, so that the second image capturer 120 can image the object OBJ according to the position information LI to obtain time-of-flight sensing information TOFSI.

The processor 140 is coupled to the first image capturer 110 and the second image capturer 120. The processor 140 may receive the position information LI generated by the first image capturer 110, and generate a corresponding control signal CS according to the position information LI. In addition, the processor 140 may also receive the time-of-flight sensing information TOFSI generated by the second image capturer 120, and calculate depth information DEI related to the object OBJ according to the time-of-flight sensing information TOFSI.

The light source generator 130 is coupled to the processor 140. The light source generator 130 may generate light beams BM in various different forms on the object OBJ according to the control signal CS. In this embodiment, the light source generator 130 may include a light emitter 131 and a rotating platform 132. The rotating platform 132 is coupled to the processor 140 to receive the control signal CS, and the light emitter 131 may be disposed on the rotating platform 132.

In this embodiment, through the control signal CS, the processor 140 may control the rotating platform 132 to perform a periodical rotation, and cause the light emitter 131 to be oriented in a direction indicated by the position information LI, in order to generate the light beam BM on the object OBJ.

It is notable that, in this embodiment, relative positions of the first image capturer 110 and the second image capturer 120 may be fixed, and the first image capturer 110 and the second image capturer 120 can be oriented in a same direction to scan and image the object OBJ. That is to say, the distance between the first image capturer 110 and the second image capturer 120 in this embodiment is fixed.

In this embodiment, the first image capturer 110 may, for instance, be a color sensor, and the second image capturer 120 may, for instance, be a time-of-flight sensor, but the disclosure is not limited thereto.

In addition, the light emitter 131 in this embodiment may, for instance, be a vertical cavity surface emitting laser (VCSEL), a laser diode, or a light emitting diode, but the disclosure is not limited thereto.

Next, the operation details of the movable electronic device 100 will be described. When the movable electronic device 100 is operating in a standby mode (e.g., before the movable electronic device 100 performs the traveling operation), the movable electronic device 100 may first scan a current picture in situ through the first image capturer 110. Moreover, the processor 140 may perform calibration on the first image capturer 110 and the second image capturer 120 in advance.

For instance, before the first image capturer 110 images a moving object OBJ, the movable electronic device 100 may perform an image capturing operation on a predetermined calibration image (e.g., a checkerboard image) in advance through the first image capturer 110 and the second image capturer 120. Moreover, according to the captured results from the first image capturer 110 and the second image capturer 120, the processor 140 configures the origin position of the picture captured by the first image capturer 110 to correspond to the origin position of the picture captured by the second image capturer 120, and thereby calibrates the coordinate transformation relations between the first image capturer 110 and the second image capturer 120.

It is noted that the calibration method of the first image capturer 110 and the second image capturer 120 may be determined according to design requirements. Persons having ordinary skill in the art can also apply familiar technologies used for camera image calibration to the disclosure. The disclosure is not limited to the abovementioned calibration method.

Subsequently, when the movable electronic device 100 is in an operating mode (e.g., when the movable electronic device 100 initiates the traveling operation in a certain direction), the movable electronic device 100 may first scan an area in the picture according to the ambient light through the first image capturer 110. During the process of scanning, when the first image capturer 110 captures an image of the object OBJ at a first time point, the first image capturer 110 determines, according to the image, that the object OBJ is located at a first coordinate position at the first time point. When the first image capturer 110 captures an image of the object OBJ at a second time point later than the first time point, the first image capturer 110 determines, according to the image, that the object OBJ is located at a second coordinate position at the second time point.

Then, the first image capturer 110 may further determine whether the object OBJ is a moving object OBJ through subtraction between the first coordinate position and the second coordinate position. For instance, where the first image capturer 110 obtains a difference through subtraction between the first coordinate position and the second coordinate position, it means that the coordinate position of the object OBJ has changed. At this time, the first image capturer 110 can determine that the object OBJ is a moving object OBJ, then obtain the position information LI related to the object OBJ according to the captured images, and provide the position information LI to the second image capturer 120 and the processor 140.

In contrast, where the first image capturer 110 does not obtain the difference through subtraction between the first coordinate position and the second coordinate position, it means that the coordinate position of the object OBJ has not changed. At this time, the first image capturer 110 can determine that the object OBJ is not a moving object OBJ and continues scanning.

The method in which the first image capturer 110 detects the moving object OBJ may be determined according to design requirements. Persons having ordinary skill in the art may also apply familiar technologies used for detecting objects OBJ (e.g., Mask RCNN) to the disclosure. The disclosure is not limited to the abovementioned detection method.

Notably, in the light source generator 130 in this embodiment, the rotating platform 132 may have one or two actuators (such as motors). In addition, after the first image capturer 110 captures the images of the moving object OBJ, the light source generator 130 rotates the rotating platform 132 through the actuators according to the control signal CS, so that the light emitter 131 can be oriented in a direction indicated by the position information LI according to the rotation direction of the rotating platform 132, to generate the light beams BM in various different forms on the object OBJ.

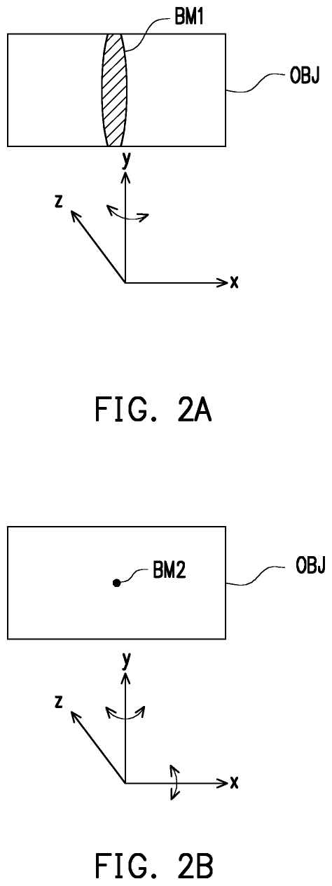

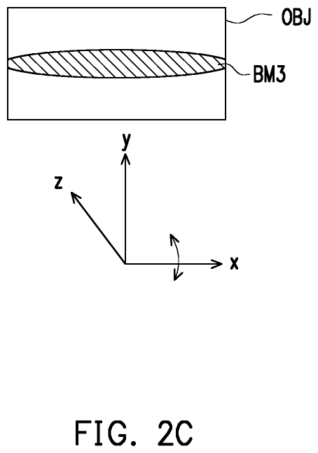

In this regard, reference is made to FIG. 1 and FIG. 2A to FIG. 2C at the same time. FIGS. 2A to 2C are schematic diagrams of the light emitter of FIG. 1 generating light beams in various different forms when the rotating platform rotates in different directions according to an embodiment of the disclosure. For instance, in an application scenario shown in FIG. 2A, when the rotating platform 132 rotates around the y-axis through the actuator according to the control signal CS, the light emitter 131 can be oriented in the direction indicated by the position information LI according to the rotation direction of the rotating platform 132, to generate a vertical linear light beam BM1 on the object OBJ.

Moreover, in another application scenario shown in FIG. 2B, when the rotating platform 132 rotates around the x-axis through one of the actuators, and at the same time rotates around the y-axis through the other of the actuators, according to the control signal CS, the light emitter 131 can be oriented in the direction indicated by the position information LI according to the rotation direction of the rotating platform 132, to generate a single-dot shaped light beam BM2 on the object OBJ.

In addition, in yet another application scenario shown in FIG. 2C, when the rotating platform 132 rotates around the x-axis through the actuator according to the control signal CS, the light emitter 131 can be oriented in the direction indicated by the position information LI according to the rotation direction of the rotating platform 132, to generate a horizontal linear light beam BM3 on the object OBJ. The abovementioned x-axis, y-axis, and z-axis describe a three-dimensional space.

That is to say, in this embodiment, according to the position information LI and the control signal CS, the light source generator 130 may rotate the rotating platform 132 to a specified position or angle, and cause the light emitter 131 to be oriented in a specified direction to generate a light beam (i.e., the light beam BM1, BM2, or BM3) with a narrow field of view (FOV) on the moving object OBJ. Moreover, the light emitter 131 in this embodiment can concentrate the light projected on the object OBJ by generating a light beam with a narrow FOV while maintaining the original range and area of projection on the object OBJ through the rotation of the rotating platform 132. In this manner, the movable electronic device 100 in this embodiment can effectively increase the detection range and detection speed for detecting the object OBJ.

On the other hand, after the first image capturer 110 captures the images of the object OBJ, according to the position information LI, the second image capturer 120 may send an electromagnetic wave signal IR to the object OBJ in the direction indicated by the position information LI, and receive a reflected electromagnetic wave signal RIR reflected from the object OBJ to calculate the distance between the object OBJ and the second image capturer 120. The aforementioned electromagnetic wave signal may be an invisible light signal (e.g., infrared, but the disclosure is not limited thereto).

For instance, in this embodiment, when the second image capturer 120 is to capture an image, the second image capturer 120 may send the electromagnetic wave signal IR. After the electromagnetic wave signal IR reaches the object OBJ, the reflected electromagnetic wave signal RIR which is generated is received by the second image capturer 120.

Subsequently, the second image capturer 120 may calculate a time of flight of the electromagnetic wave signal IR and the reflected electromagnetic wave signal RIR based on a time difference between a time point of emitting the electromagnetic wave signal IR and a time point of receiving the reflected electromagnetic wave signal RIR, and thereby calculate the distance between the object OBJ and the second image capturer 120 to correspondingly generate the time-of-flight sensing information TOFSI and provide the same to the processor 140. Accordingly, the processor 140 can further calculate the depth information DEI related to the object OBJ according to the time-of-flight sensing information TOFSI.

Since the light emitter 131 in this embodiment can generate the light beam with a narrow FOV on the moving object OBJ, the second image capturer 120 can capture a clearer image when imaging the moving object OBJ. Accordingly, under the circumstances that the light emitter 131 generates the light beam with a narrow FOV on the moving object OBJ, the accuracy of calculating the depth information DEI related to the object OBJ by the processor 140 can be effectively increased.

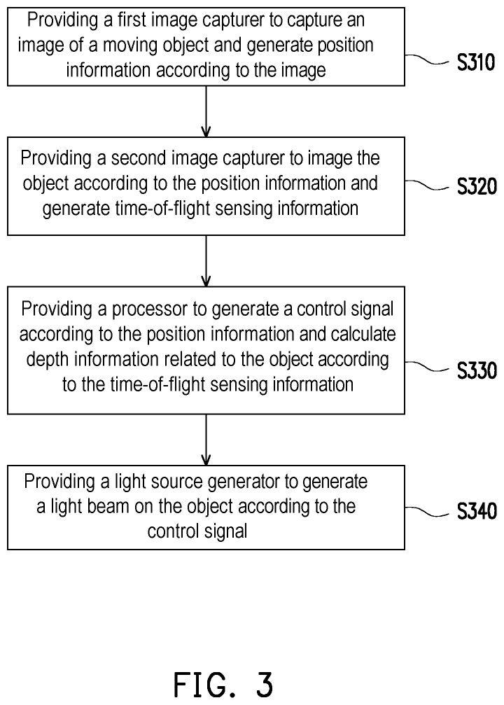

FIG. 3 is a flowchart of an operating method of a movable electronic device according to an embodiment of the disclosure. Referring to FIGS. 1 and 3 at the same time, in step S310, a first image capturer is provided to capture an image of a moving object and generate position information according to the image. In step S320, a second image capturer is provided to image the object according to the position information and generate time-of-flight sensing information.

In step S330, a processor is provided to generate a control signal according to the position information, and calculate depth information related to the object according to the time-of-flight sensing information. In step S340, a light source generator is provided to generate a light beam on the object according to the control signal.

The implementation details in each step of this embodiment have been described in the foregoing embodiments and will not be repeatedly described herein.

In summary of the foregoing, the light source generator of the movable electronic device according to the embodiments of the disclosure can rotate the rotating platform to the specified position or angle according to the position information provided by the first image capturer, and cause the light emitter to be oriented in the specified direction to generate the light beam with a narrow FOV on the moving object. In this manner, the movable electronic device of the disclosure can effectively increase the detection range and detection speed for detecting objects, and effectively increase the accuracy of calculating the depth information related to the object by the processor.

What is claimed is:

1. A movable electronic device comprising:
a first image capturer configured to capture an image of an object which is moving, and generate position information according to the image;
a second image capturer, receiving the position information, and configured to image the object according to the position information and generate time-of-flight sensing information;
a processor, coupled to the first image capturer and the second image capturer, and configured to generate a control signal according to the position information and calculate depth information related to the object according to the time-of-flight sensing information; and
a light source generator coupled to the processor and generating a light beam on the object according to the control signal.

2. The movable electronic device according to claim 1, wherein the light source generator further comprises:
a rotating platform coupled to the processor to be controlled by the control signal; and
a light emitter disposed on the rotating platform,
wherein the processor controls the rotating platform to perform a periodical rotation through the control signal, and causes the light emitter to be oriented in a direction indicated by the position information to generate the light beam on the object.

3. The movable electronic device according to claim 2, wherein the rotating platform causes the light emitter to generate a linear light beam or a single-dot shaped light beam on the object according to the control signal.

4. The movable electronic device according to claim 2, wherein the light emitter is a vertical cavity surface emitting laser.

5. The movable electronic device according to claim 1, wherein relative positions of the first image capturer and the second image capturer are fixed, and the first image capturer and the second image capturer are oriented in a same direction to image the object.

6. The movable electronic device according to claim 1, wherein the second image capturer is further configured to emit an electromagnetic wave signal to the object,
wherein the electromagnetic wave signal is reflected by the object to generate a reflected electromagnetic wave signal, and the second image capturer receives the reflected electromagnetic wave signal and generates the time-of-flight sensing information through calculating a time of flight of the reflected electromagnetic wave signal.

7. The movable electronic device according to claim 1, wherein the first image capturer is a color sensor, and the second image capturer is a time-of-flight sensor.

8. The movable electronic device according to claim 1, wherein before the first image capturer captures the image of the object which is moving, the processor performs a calibration operation on the first image capturer and the second image capturer in advance.

9. The movable electronic device according to claim 8, wherein the movable electronic device performs a capturing operation on a calibration image through the first image capturer and the second image capturer, and the processor calibrates coordinate transformation relations between the first image capturer and the second image capturer according to captured results from the first image capturer and the second image capturer.

10. An operating method of a movable electronic device, comprising:
providing a first image capturer to capture an image of an object which is moving and generate position information according to the image;
providing a second image capturer to image the object according to the position information and generate time-of-flight sensing information;
providing a processor to generate a control signal according to the position information and calculate depth information related to the object according to the time-of-flight sensing information; and
providing a light source generator to generate a light beam on the object according to the control signal.

11. The operating method according to claim 10, wherein the step of providing the light source generator to generate the light beam on the object according to the control signal comprises:
providing a rotating platform to be controlled by the control signal; and
controlling, by the processor, the rotating platform to perform a periodical rotation through the control signal such that a light emitter disposed on the rotating platform is oriented in a direction indicated by the position information to generate the light beam on the object.

12. The operating method according to claim 11, wherein the step of controlling, by the processor, the rotating platform to perform a periodical rotation through the control signal such that the light emitter disposed on the rotating platform is oriented in the direction indicated by the position information to generate the light beam on the object comprises:
causing, by the rotating platform, the light emitter to generate a linear light beam or a single-dot shaped light beam on the object according to the control signal.

13. The operating method according to claim 11, wherein the light emitter is a vertical cavity surface emitting laser.

14. The operating method according to claim 10, wherein relative positions of the first image capturer and the second image capturer are fixed, and the first image capturer and the second image capturer are oriented in a same direction to image the object.

15. The operating method according to claim 10, wherein the step of providing the second image capturer to image the object according to the position information and generate the time-of-flight sensing information comprises:
emitting, by the second image capturer, an electromagnetic wave signal to the object, wherein the electromagnetic wave signal is reflected by the object to generate a reflected electromagnetic wave signal; and
receiving, by the second image capturer, the reflected electromagnetic wave signal and generating the time-of-flight sensing information through calculating a time of flight of the reflected electromagnetic wave signal.

16. The operating method according to claim 10, wherein the first image capturer is a color sensor, and the second image capturer is a time-of-flight sensor.

17. The operating method according to claim 10, wherein before the step of providing the first image capturer to capture the image of the object which is moving and generate the position information according to the image, the operating method further comprises:
performing, by the processor, a calibration operation on the first image capturer and the second image capturer in advance.

18. The operating method according to claim 17, wherein the step of performing, by the processor, the calibration operation on the first image capturer and the second image capturer in advance comprises:
performing, by the first image capturer and the second image capturer, a capturing operation on a calibration image; and
calibrating, by the processor, coordinate transformation relations between the first image capturer and the second image capturer according to captured results from the first image capturer and the second image capturer.
